(19) United States
(12) Patent Application Publication
(10) Pub. No.: US 2018/0109390 A1
(43) Pub. Date: Apr. 19, 2018

(54) CERTIFICATE GENERATION

(71) Applicant: HEWLETT PACKARD ENTERPRISE DEVELOPMENT LP, Houston, TX (US)

(72) Inventors: Michael SPRATTE, Colorado Springs, CO (US); Steve ROSCIO, Colorado Springs, CO (US); Paul D VENCEL, Fort Collins, CO (US)

(21) Appl. No.: 15/564,737

(22) PCT Filed: Apr. 6, 2015
(86) PCT No.: PCT/US2015/024449

§ 371 Date: Oct. 5, 2017

(51) Int. Cl. H04L 9/32; H04L 9/14; H04L 9/30; H04L 9/00

(52) U.S. Cl. CPC H04L 9/3263; H04L 9/14; H04L 9/006; H04L 9/3247; H04L 9/30

(57) ABSTRACT

Examples disclosed herein comprise certificate generation instructions to create a key pair comprising a private key and a public key, receive a signing certificate associated with the public key comprising a configurable signing window, create an end user certificate according to the signing certificate, determine whether the configurable signing window has expired, and in response to determining that the configurable signing window has expired, discard the private key of the key pair.

### BACKGROUND

End user security certificates are used as part of a public key infrastructure (PKI) to help authenticate communications between applications and/or users. Root certificate authorities may delegate permission to generate the end user security certificates to a network of distributed certificate authorities.

### BRIEF DESCRIPTION OF THE DRAWINGS

In the accompanying drawings, like numerals refer to like components or blocks. The following detailed description references the drawings, wherein:

FIG. 1 is a block diagram of an example certificate generation device consistent with disclosed implementations;

FIG. 2 is a flowchart of an embodiment of a method for certificate generation consistent with disclosed implementations; and

FIG. 3 is a block diagram of a system for certificate generation consistent with disclosed implementations.

### DETAILED DESCRIPTION

As described above, a root certificate authority (RCA) may generate signing certificates for a set of distributed certificate authorities (DCAs). In some embodiments, the RCA may be situated in a secure environment with little to no direct network connectivity to public and/or insecure networks and devices. For example, the RCA may operate on a server in a physically secure facility and with firewall controlled network connections. The DCAs, however, may be situated in less secure environments and/or may be accessible from public networks such as the Internet. The DCAs may be used to generate certificates for end users, services, and/or applications in order to limit the workload and exposure of the RCA.

In the description that follows, reference is made to the term, “machine-readable storage medium.” As used herein, the term “machine-readable storage medium” refers to any electronic, magnetic, optical, or other physical storage device that stores executable instructions or other data (e.g., a hard disk drive, random access memory, flash memory, etc.).

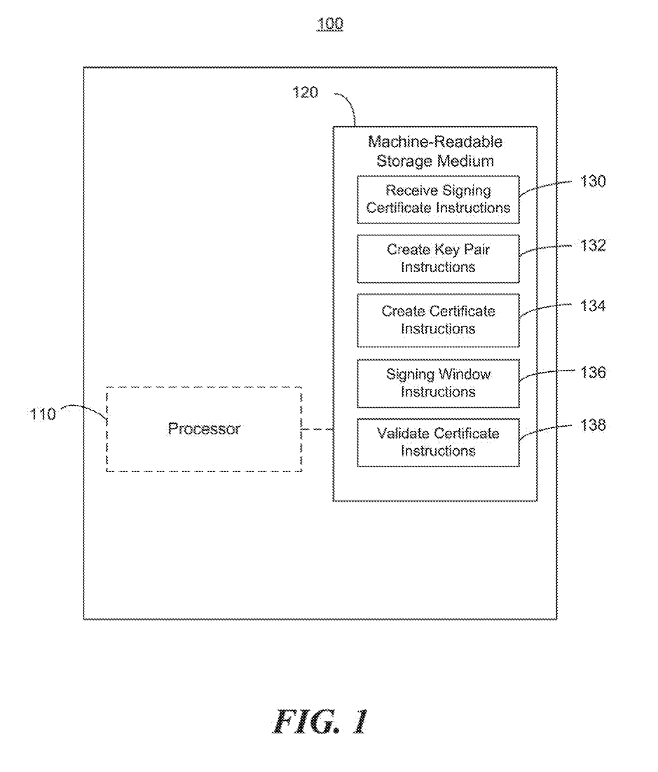

Referring now to the drawings, FIG. 1 is a block diagram of an example certificate generation device 100 consistent with disclosed implementations. Certificate generation device 100 may comprise a processor 110 and a non-transitory machine-readable storage medium 120. Certificate generation device 100 may comprise a computing device such as a server computer, a desktop computer, a laptop computer, a handheld computing device, a mobile phone, or the like.

Processor 110 may comprise a central processing unit (CPU), a semiconductor-based microprocessor, or any other hardware device suitable for retrieval and execution of instructions stored in machine-readable storage medium 120. In particular, processor 110 may fetch, decode, and execute a plurality of receive signing certificate instructions 130, create key pair instructions 132, create certificate instructions 134, signing window instructions 136, and validate certificate instructions 138 to implement the functionality described in detail below.

Executable instructions such as receive signing certificate instructions 130, create key pair instructions 132, create certificate instructions 134, signing window instructions 136, and validate certificate instructions 138 may be stored in any portion and/or component of machine-readable storage medium 120. The machine-readable storage medium 120 may comprise both volatile and/or nonvolatile memory and data storage components. Volatile components are those that do not retain data values upon loss of power. Nonvolatile components are those that retain data upon a loss of power.

The machine-readable storage medium 120 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, and/or a combination of any two and/or more of these memory components. In addition, the RAM may comprise, for example, static random access memory (SRAM), dynamic random access memory (DRAM), and/or magnetic random access memory (MRAM) and other such devices. The ROM may comprise, for example, a programmable read-only memory (PROM), an erasable programmable read-only memory (EPROM), an electrically erasable programmable read-only memory (EEPROM), and/or other like memory device.

Create key pair instructions 132 may create a key pair comprising a private key and a public key. Key pair-based cryptography, also known as asymmetric cryptography, is a class of cryptographic algorithms that requires two mathematically linked separate keys. The public key may be used to encrypt plaintext or to verify a digital signature and the private key may be used to decrypt ciphertext or to create a digital signature. In some embodiments, the RSA algorithm may be used to create the key pair.

Receive signing certificate instructions 130 may receive a signing certificate comprising a configurable signing window. For example, a distributed certificate authority (DCA) may request a signing certificate associated with the public key of the created key pair from a root certificate authority (RCA). Certificates may comprise elements such as a serial number to uniquely identify the certificate, a subject of the entity identified, an identification of the issuing entity that verified the information and issued the certificate, a valid date range, and a public key of a key pair.

The configurable signing window may comprise a duration during which the DCA may use the signing certificate to sign end user public keys. The valid date range of the signing certificate may comprise a validity window during which the signing certificate may be used to validate end user keys that were signed during the signing window. The signing window may be much shorter than the validity window. For example, the signing window may comprise 24 hours while the validity window may comprise a year.

Create certificate instructions 134 may create an end user certificate according to the key pair. For example, an end user may generate their own key pair to use in signing and/or encrypting email. The user may provide the public key to the DCA and the DCA may create and sign the end user certificate comprising the public key using the signing certificate from the RCA.

In some embodiments, the DCA may require verification of the end user's identity before signing the end user certificate. Such validation my comprise determining whether the request came from a valid domain for the end user's claimed identity and/or receiving a one-time password or authentication code supplied by the end user.

In some embodiments, the DCA may provide copies of the created certificates to the RCA. For example, the DCA may submit each created certificate individually and/or may provide a batch of certificates to the RCA at regular intervals. The RCA may distribute lists of such end user certificates to other DCAs to aid in validating those end user certificates by the other DCAs.

Signing window instructions 136 may determine whether the configurable signing window has expired. For example, the signing window may expire 24 hours after the signing certificate is received from the RCA and/or whenever the DCA shuts down or restarts. In response to determining that the configurable signing window has expired, the private key of the key pair may be discarded. The public key may be retained for the duration of the validity window for use in validating end user certificates.

The private key of the created key pair may be stored in volatile memory. In some embodiments, the private key may be kept only in non-swappable, non-pageable volatile memory to provide additional security by ensuring that the private key is never written to disk.

Validate certificate instructions 138 may receive requests from various entities to validate an end user certificate signed by the DCA. For example, a software application's certificate may be used to certify that the application has not been modified. A user who wishes to install the software application may request that the DCA validate the software application's certificate before trusting that certification.

In some embodiments, the end user certificate may also comprise a validity window. The validity window may be for less time than the validity window of the signing certificate. For example, the signing certificate validity window may comprise 365 days and the end user validity window may comprise 180, 300, or 350 days. The signing certificate may be retained for the full duration of its validity window by the DCA and/or the RCA. In some embodiments, the signing certificates may be made available to other DCAs to aid in validating end user certificates.

The signing certificate may be discarded after its validity window expires as no end user certificates will remain valid after it expires and the signing certificate will not be needed to validate those end user certificates.

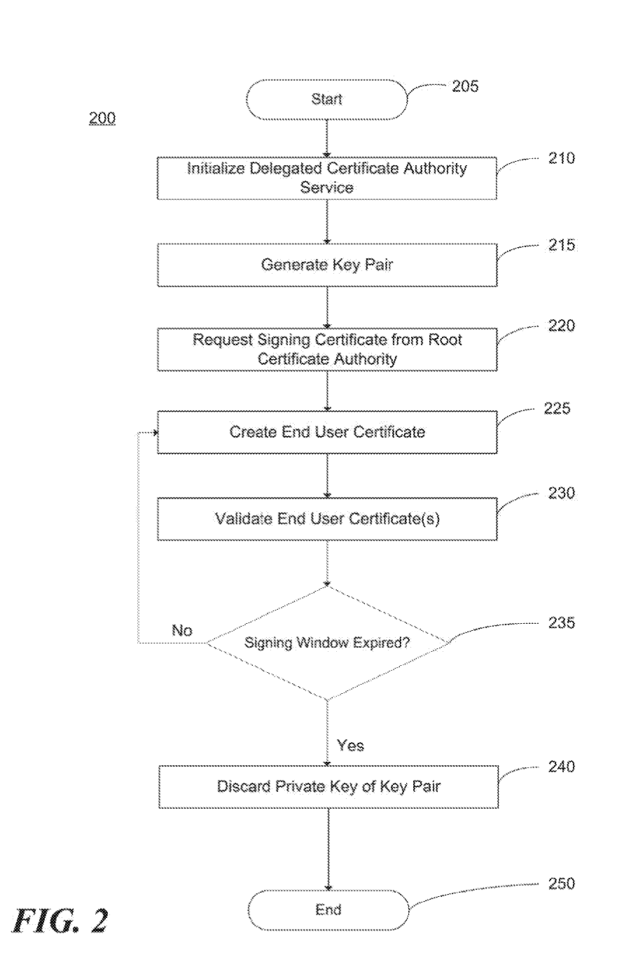

FIG. 2 is a flowchart of an embodiment of a method 200 for certificate generation consistent with disclosed implementations. Although execution of method 200 is described below with reference to the components of certificate generation device 100, other suitable components for execution of method 200 may be used.

Method 200 may start in block 205 and proceed to block 210 where device 100 may initialize a delegated certificate authority service. For example, a server may start up a programmatic service to act as a delegated certificate authority. The start up may occur automatically, such as after a reset of the server, or manually, such as when requested by an administrator.

Method 200 may proceed to block 215 where device 100 may generate a key pair comprising a public key and a private key. For example, create key pair instructions 132 may create a key pair comprising a private key and a public key. Key pair-based cryptography, also known as asymmetric cryptography, is a class of cryptographic algorithms that requires two mathematically linked separate keys. The public key may be used to encrypt plaintext or to verify a digital signature and the private key may be used to decrypt encrypted text and/or to create a digital signature. In some embodiments, the RSA algorithm may be used to create the key pair.

Method 200 may proceed to block 220 where device 100 may request a first signing certificate associated with the public key from a root certificate authority, wherein the signing certificate comprises a configurable signing window.

Method 200 may proceed to block 225 where device 100 may create a first end user certificate according to the first signing certificate. For example, receive signing certificate instructions 130 may receive a signing certificate comprising a configurable signing window. For example, a distributed certificate authority (DCA) may request a signing certificate associated with the public key of the created key pair from a root certificate authority (RCA). Certificates may comprise elements such as a serial number to uniquely identify the certificate, a subject of the entity identified, an identification of the issuing entity that verified the information and issued the certificate, a valid date range, and a public key of a key pair.

The configurable signing window may comprise a duration during which the DCA may use the signing certificate to sign end user public keys. The valid date range of the signing certificate may comprise a validity window during which the signing certificate may be used to validate end user keys that were signed during the signing window. The signing window may be much shorter than the validity window. For example, the signing window may comprise 24 hours while the validity window may comprise a year.

Method 200 may proceed to block 230 where device 100 may validate a second end user certificate according to a second signing certificate, wherein the second signing certificate comprises an expired signing window. For example, validate certificate instructions 138 may receive requests from various entities to validate an end user certificate signed by the DCA. For example, a software application's certificate may be used to certify that the application has not been modified. A user who wishes to install the software application may request that the DCA validate the software application's certificate before trusting that certification.

In some embodiments, the end user certificate may also comprise a validity window. The validity window may be for less time than the validity window of the signing certificate. For example, the signing certificate validity window may comprise 365 days and the end user validity window may comprise 180, 300, or 350 days. The signing certificate may be retained for the full duration of its validity window by the DCA and/or the RCA. In some embodiments, the signing certificates may be made available to other DCAs to aid in validating end user certificates.

Method 200 may proceed to block 235 where device 100 may determine whether the configurable signing window has expired. For example, the signing window may expire 24 hours after the signing certificate is received from the RCA and/or whenever the DCA shuts down or restarts.

If the configurable signing window has not expired, method 200 may return to block 225 and continue to create end user certificates as requested. In response to determining that the configurable signing window has expired, method 200 may proceed to block 240 where device 100 may discard the private key of the generated key pair. For example, the private key of the created key pair may be erased from volatile memory. In some embodiments, the private key may be kept only in non-swappable, non-pageable volatile memory to provide additional security by ensuring that the private key is never written to disk. Method 200 may then end at block 250.

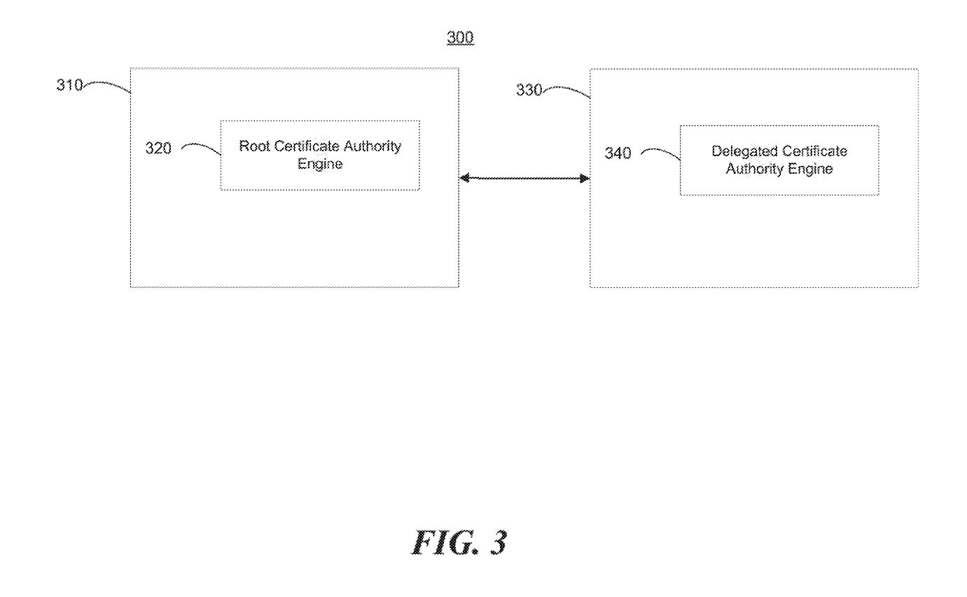

FIG. 3 is a block diagram of a system 300 for certificate generation consistent with disclosed implementations. System 300 may comprise a first computing device 310 comprising a root certificate authority engine 320 and a second computing device 330 comprising a delegated certificate authority engine 340. In some embodiments, root certificate authority engine 320 and delegated certificate authority engine 340 may be associated with the same computing device. Computing devices 310, 330 may comprise, for example, a general and/or special purpose computer, server, mainframe, desktop, laptop, tablet, smart phone, game console, and/or any other system capable of providing computing capability consistent with providing the implementations described herein. Root certificate authority engine 320 and delegated certificate authority engine 340 may each comprise, for example, instructions stored a machine readable medium executable by a processor, logic circuitry, and/or other implementations of hardware and/or software.

A certificate authority (CA) is an entity in a Public Key Infrastructure (PKI) that issues digital certificates using public key cryptography. Public key cryptography uses two keys, a private key that remains known only to the certificate owner, and a public key that may be widely distributed. A CA uses its private key to sign a digital certificate for another entity, such as an end user, which can then be validated using the CA's signing certificate.

Root certificate authority (RCA) engine 320 may receive requests for signing certificates from each of a plurality of delegated certificate authorities, receive a notice of compromise associated with a plurality of end user certificates from a compromised delegated certificate authority, and distribute a certificate revocation list associated with the plurality of end user certificates to each of the plurality of delegated certificate authorities. In some embodiments, RCA engine 320 may provide signing certificates to a plurality of delegated certificate authorities (DCAs), which may be responsible for creating and/or signing end user certificates. The RCA may remain in a secure physical location and on a secure communication network while the DCAs may connect with less secure and/or public networks.

Requests for signing certificates may comprise a public key of a public/private key pair generated by each of the DCAs. The RCA may create the signing certificate comprising the public key upon verification of the DCAs credentials, thereby conferring authority upon the DCA to create and/or sign certificates for other entities on behalf of the RCA.

DCA engine 340 may generate a key pair comprising a public key and a private key, request a signing certificate from the root certificate authority engine according to the public key, receive the signing certificate comprising the public key from the root certificate authority engine, wherein the signing certificate comprises a configurable signing window, store a copy of the public key in a non-volatile memory, and store the private key in a volatile memory. DCA engine 340 may further create a first end user certificate according to the first signing certificate, validate a second end user certificate according to a second signing certificate, wherein the second signing certificate comprises an expired signing window, determine whether the configurable signing window has expired, and in response to determining that the configurable signing window has expired, discard the private key of the generated key pair from the volatile memory.

In some embodiments, DCA engine 340 may create the key pair at startup. The private key may be stored in non-paged, non-swappable memory that will not be preserved across process or system restarts. DCA engine 340 may then request a signing certificate, such as an X.509 certificate, from RCA engine 320. If RCA engine 320 is unavailable, DCA engine 340 may wait until RCA engine 320 comes back online and it can successfully request a certificate before progressing to the next step. DCA engine 340 may receive certificate signing requests from end users until either a system shutdown request or the DCA certificate signing window has expired. Upon such a shutdown request or signing window expiration, DCA engine 340 may destroy the private key of the key pair, such as by erasing it from memory.

In some embodiments, DCA engine 340 may create end user certificates in a hostile and/or insecure network environment as one of a plurality of distributed DCAs. For example, the DCAs may connect to various points on the public Internet throughout the world while the RCA may only be reached via a secure network, such as a virtual private network (VPN). Each of the DCAs may comprise a unique public/private key pair and may re-create its signing certificate at frequent intervals, such as every 24 hours—the signing window for the certificate. The DCAs' signing certificates may comprise a validity window—the time that end user certificates issued under that signing certificate may remain active and be validated—for a longer period, such as a year. User certificates may comprise a valid lifetime less than DCA validity window so that they do not expire before their signing certificate does.

If a DCA's private key is compromised, all certificates issued and/or signed by the DCA during the short signing window may also be considered compromised. If a DCA's private key is compromised, DCA engine 340 may submit the certificate's ID to RCA engine 320. RCA engine 320 may add the compromised DCA singing certificate and/or end user certificates issued according to the now untrusted certificate to a certificate revocation list. This may revoke all user certificates issued by the compromised DCA signing certificate. The certificate revocation list may be distributed to other DCAs for referencing whenever an end user certificate needs to be validated.

The disclosed examples may include systems, devices, computer-readable storage media, and methods for progressive buffer generation. For purposes of explanation, certain examples are described with reference to the components illustrated in FIGS. 1-3. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Moreover, as used in the specification and the appended claims, the singular forms “a,” “an,” and “the” are intended to include the plural forms as well, unless the context indicates otherwise. Additionally, although the terms first, second, etc. may be used herein to describe various elements, these elements should not be limited by these terms. Instead, these terms are only used to distinguish one element from another.

Further, the sequence of operations described in connection with the Figures are examples and are not intended to be limiting. Additional or fewer operations or combinations of operations may be used or may vary without departing from the scope of the disclosed examples. Thus, the present disclosure merely sets forth possible examples of implementations, and many variations and modifications may be made to the described examples. All such modifications and variations are intended to be included within the scope of this disclosure and protected by the following claims.

We claim:

1. A non-transitory machine-readable storage medium including instructions for certificate generation which, when executed by a processor, cause the processor to:
create a key pair comprising a private key and a public key;
receive a signing certificate associated with the public key comprising a configurable signing window;
create an end user certificate according to the signing certificate;
determine whether the configurable signing window has expired; and
in response to determining that the configurable signing window has expired, discard the private key of the key pair.

2. The non-transitory machine-readable medium of claim 1, wherein the signing certificate further comprises a validity window.

3. The non-transitory machine-readable medium of claim 2, wherein the end user certificate comprises a second validity window and wherein the second validity window is less than the validity window of the signing certificate.

4. The non-transitory machine-readable medium of claim 2, wherein the instructions cause the processor to retain the signing certificate for the duration of the validity window.

5. The non-transitory machine-readable medium of claim 1 wherein the instructions cause the processor to retain the private key in a volatile memory.

6. The non-transitory machine-readable medium of claim 1 wherein the signing certificate is received from a root certificate authority.

7. A computer-implemented method for certificate generation comprising:
initializing a delegated certificate authority service;
generating a key pair comprising a public key and a private key;
requesting a first signing certificate associated with the public key from a root certificate authority, wherein the signing certificate comprises a configurable signing window;
creating a first end user certificate according to the first signing certificate;
validating a second end user certificate according to a second signing certificate, wherein the second signing certificate comprises an expired signing window;
determining whether the configurable signing window has expired; and
in response to determining that the configurable signing window has expired, discarding the private key of the generated key pair.

8. The computer-implemented method of claim 7, wherein the second end user certificate is validated according to a second public key associated with the second signing certificate.

9. The computer-implemented method of claim 8, wherein the public key of the generated key pair and the second public key are stored in a non-volatile memory.

10. The computer-implemented method of claim 8, further comprising providing the public key of the generated key pair and the second public key to the root certificate authority.

11. The computer-implemented method of claim 7, wherein validating the second end user certificate comprises determining whether the second end user certificate is associated with a certificate revocation list.

12. The computer-implemented method of claim 11, further comprising receiving the certificate revocation list from the root certificate authority.

13. The computer-implemented method of claim 7, wherein the private key of the generated key pair is stored in a volatile memory.

14. The computer-implemented method of claim 13, wherein the private key of the generated key pair is discarded upon a shutdown of the delegated certificate authority service.

15. A system for certificate generation, comprising:
a root certificate authority engine to:
receive requests for signing certificates from a plurality of delegated certificate authorities,
receive a notice of compromise associated with a plurality of end user certificates from a compromised delegated certificate authority, and
distribute a certificate revocation list associated with the plurality of end user certificates to each of the plurality of delegated certificate authorities; and
the delegated certificate authority engine to:
generate a key pair comprising a public key and a private key,
request a signing certificate from the root certificate authority engine according to the public key,
receive the signing certificate comprising the public key from the root certificate authority engine, wherein the signing certificate comprises a configurable signing window,
store a copy of the public key in a non-volatile memory,
store the private key in a volatile memory,
create a first end user certificate according to the first signing certificate,
validate a second end user certificate according to a second signing certificate, wherein the second signing certificate comprises an expired signing window,
determine whether the configurable signing window has expired, and
in response to determining that the configurable signing window has expired, discard the private key of the generated key pair from the volatile memory.
